(19) United States
(12) Patent Application Publication
(10) Pub. No.: US 2022/0045776 A1
(43) Pub. Date: Feb. 10, 2022

(54) COMPUTING DEVICE AND OPERATING METHOD THEREFOR

(71) Applicant: SAMSUNG ELECTRONICS CO., LTD., Suwon-si (KR)

(72) Inventors: SaeEun CHOI, Suwon-si (KR); Jinhyun KIM, Suwon-si (KR); Gihoon PARK, Suwon-si (KR); Sangshin PARK, Suwon-si (KR); Eun-An CHO, Suwon-si (KR)

(73) Assignee: SAMSUNG ELECTRONICS CO., LTD., Suwon-si (KR)

(21) Appl. No.: 17/281,356

(22) PCT Filed: Jul. 26, 2019
(86) PCT No.: PCT/KR2019/009367

§ 371 Date: Mar. 30, 2021

(30) Foreign Application Priority Data
Dec. 21, 2018 (KR) 10-2018-0167888

(51) Int. Cl. H04H 60/37; G10L 15/26; G10L 15/00; G06N 3/08; G06N 3/04; H04N 21/442; G06F 40/279

(52) U.S. Cl. CPC H04H 60/372; G10L 15/26; G10L 15/005; G10L 2015/088; G06N 3/0454; H04N 21/44204; G06F 40/279; G06N 3/08

(57) ABSTRACT

Provided are an artificial intelligence (AI) system that simulates functions of a human brain such as recognition and judgment by utilizing a machine learning algorithm such as deep learning, etc. and an application of the AI system. A computing apparatus is disclosed. A computing apparatus comprises a memory storing instructions and a processor executing the instructions in the memory to obtain a keyword corresponding to a broadcast channel from a speech signal included in a broadcast signal received through the broadcast channel, determine a relation between genre information of the broadcast channel obtained from metadata about the broadcast channel and the obtained keyword and determine a genre of the broadcast channel based on the genre information obtained from the metadata or by analyzing an image signal included in the broadcast signal, according to the determined relation.

### TECHNICAL FIELD

The disclosure relates to a computing device and an operating method thereof, and more particularly, to a method and device for determining a genre of a reproduced channel in real time.

### BACKGROUND ART

When a user wishes to use content through an image display apparatus or the like, the user may select a desired channel through a program guide and use the content output from the channel.

An artificial intelligence (AI) system is a computer system with human level intelligence. Unlike an existing rule-based smart system, the AI system is a system that trains itself autonomously, makes decisions, and becomes increasingly smarter. The more the AI system is used, the more the recognition rate of the AI system may improve and the AI system may more accurately understand a user preference, and thus, an existing rule-based smart system is being gradually replaced by a deep learning based AI system.

### DISCLOSURE

### Technical Solution

According to an embodiment of the disclosure, a computing apparatus includes a memory storing one or more instructions; and a processor configured to execute the one or more instructions stored in the memory to: obtain a keyword corresponding to a broadcast channel from a speech signal included in a broadcast signal received through the broadcast channel; determine a relation between genre information of the broadcast channel obtained from metadata about the broadcast channel and the obtained keyword; and determine a genre of the broadcast channel based on the genre information obtained from the metadata or by analyzing an image signal included in the broadcast signal, according to the determined relation.

### DESCRIPTION OF DRAWINGS

FIG. 1 is a diagram illustrating an example in which an image display apparatus outputs contents of channels classified for each genre, according to an embodiment of the disclosure;

FIG. 2 is a block diagram illustrating a configuration of a computing apparatus according to an embodiment of the disclosure;

FIG. 3 is a block diagram illustrating a configuration of a computing apparatus according to another embodiment of the disclosure;

FIG. 4 is a block diagram illustrating a configuration of a computing apparatus according to another embodiment of the disclosure;

FIG. 5 is a block diagram illustrating a configuration of a computing apparatus according to another embodiment of the disclosure;

FIG. 6 is a flowchart illustrating a method of determining a genre of a channel, according to an embodiment of the disclosure;

FIG. 7 is a flowchart illustrating a method of determining a genre of a channel performed by a computing apparatus and an image display apparatus when the computing apparatus is included in an external server, according to an embodiment of the disclosure;

FIG. 8 is a diagram for explaining a computing apparatus for obtaining a text signal from a speech signal, according to an embodiment of the disclosure;

FIG. 9 is a diagram for explaining a computing apparatus for obtaining keywords from a text signal, according to an embodiment of the disclosure;

FIG. 10 is a diagram for explaining a computing apparatus for obtaining numerical vectors from keywords and genre information, according to an embodiment of the disclosure;

FIG. 11 (is one graph showing numerical vectors of FIG. 10, and FIG. 12 is another graph showing numerical vectors of FIG. 10;

FIG. 13 is a diagram for explaining a computing apparatus for determining a genre of a channel by using an image signal and a keyword, according to an embodiment of the disclosure;

FIG. 14 is a block diagram illustrating a configuration of a processor according to an embodiment of the disclosure;

FIG. 15 is a block diagram of a data learner according to an embodiment of the disclosure; and

FIG. 16 is a block diagram of a data determiner according to an embodiment of the disclosure.

### MODE FOR INVENTION

Embodiments of the disclosure will be described in detail in order to fully convey the scope of the disclosure and enable one of ordinary skill in the art to embody and practice the disclosure. The disclosure may, however, be embodied in many different forms and should not be construed as being limited to the embodiments set forth herein.

Although general terms widely used at present were selected for describing the disclosure in consideration of the functions thereof, these general terms may vary according to intentions of one of ordinary skill in the art, case precedents, the advent of new technologies, and the like. Hence, the terms must be defined based on their meanings and the contents of the entire specification, not by simply stating the terms.

The terms used in the disclosure are merely used to describe particular embodiments of the disclosure, and are not intended to limit the scope of the disclosure.

Throughout the specification, it will be understood that when an element is referred to as being “connected” to another element, it may be “directly connected” to the other element or “electrically connected” to the other element with intervening elements therebetween.

The use of the terms “a” and “an” and “the” and similar referents in the context of describing the disclosure (especially in the context of the following claims) are to be construed to cover both the singular and the plural. Also, the steps of all methods described herein can be performed in any suitable order unless otherwise indicated herein or otherwise clearly contradicted by context. Embodiments of the disclosure are not limited to the described order of the operations.

Thus, the expression “according to an embodiment” used in the entire disclosure does not necessarily indicate the same embodiment of the disclosure.

The aforementioned embodiments of the disclosure may be described in terms of functional block components and various processing steps. Some or all of such functional blocks may be realized by any number of hardware and/or software components configured to perform the specified functions. For example, functional blocks according to the disclosure may be realized by one or more microprocessors or by circuit components for a certain function. In addition, for example, functional blocks according to the disclosure may be implemented with any programming or scripting language. The functional blocks may be implemented in algorithms that are executed on one or more processors. Furthermore, the disclosure described herein could employ any number of techniques according to the related art for electronics configuration, signal processing and/or control, data processing and the like. The words “mechanism”, “element”, “means”, and “configuration” are used broadly and are not limited to mechanical or physical embodiments of the disclosure.

Furthermore, the connecting lines or connectors between components shown in the various figures presented are intended to represent exemplary functional relationships and/or physical or logical couplings between the components. Connections between components may be represented by many alternative or additional functional relationships, physical connections or logical connections in a practical apparatus.

The terms, such as ‘unit’ or ‘module’, etc., described herein should be understood as a unit that processes at least one function or operation and that may be embodied in a hardware manner, a software manner, or a combination of the hardware manner and the software manner.

Throughout the disclosure, the expression “at least one of a, b or c” indicates only a, only b, only c, both a and b, both a and c, both b and c, all of a, b, and c, or variations thereof. Hereinafter, the disclosure will be described in detail by explaining embodiments of the disclosure with reference to the attached drawings.

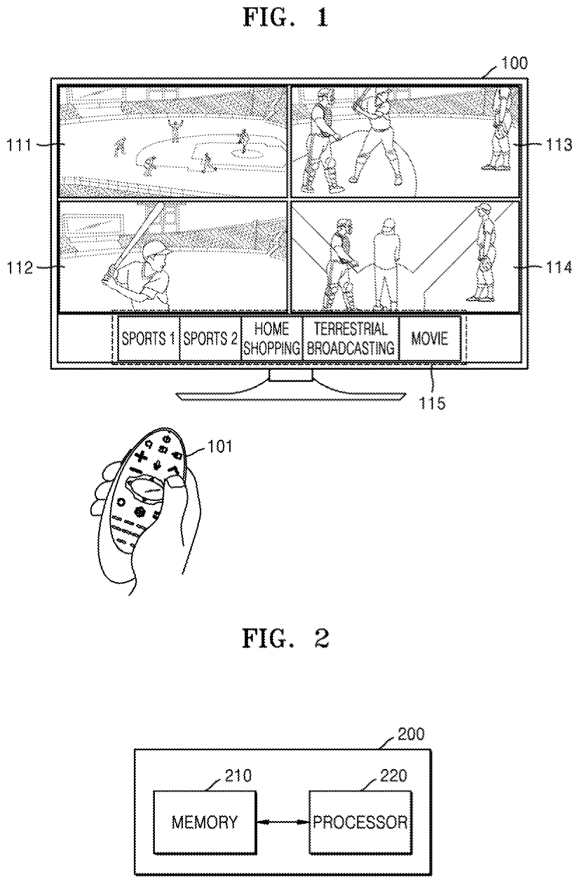

FIG. 1 is a diagram illustrating an example in which an image display apparatus 100 outputs contents of channels classified for each genre according to an embodiment of the disclosure.

Referring to FIG. 1, the image display apparatus 100 may be a TV, but not limited thereto, and may be implemented as an electronic apparatus including a display. For example, the image display apparatus 100 may be implemented as various electronic apparatuses such as a mobile phone, a tablet PC, a digital camera, a camcorder, a laptop computer, a desktop, an electronic book terminal, a digital broadcast terminal, a personal digital assistant (PDA), a portable multimedia player (PMP), navigation, an MP3 player, a wearable device, and the like. Also, the image display apparatus 100 may be a fixed type or mobile type, and may be a digital broadcast receiver capable of receiving digital broadcast.

Also, the image display apparatus 100 may be implemented as a curved display device having a curvature or a flexible display device capable of adjusting the curvature as well as a flat display device. The output resolution of the image display apparatus 100 may include, for example, high definition (HD), full HD, ultra HD, or ultra HD, or a resolution that is clearer than the ultra HD.

The image display apparatus 100 may be controlled by a control apparatus 101, and the control apparatus 101 may be implemented as various types of apparatuses for controlling the image display apparatus 100 such as a remote controller or a mobile phone. Alternatively, when a display of the image display apparatus 100 is implemented as a touch screen, the control apparatus 101 may be replaced with a user's finger, an input pen, or the like.

In addition, the control apparatus 101 may control the image display apparatus 100 using near field communication including an infrared ray or Bluetooth. The control apparatus 101 may use at least one of a provided key or button, a touchpad, a microphone (not shown) capable of receiving speech of a user, or a sensor (not shown) capable of motion recognition of the control apparatus 101 to control functions of the image display apparatus 100.

The control apparatus 101 may include a power on/off button for turning on or off the image display apparatus 100. Also, the control apparatus 101 may change channels of the image display apparatus 100, adjust the volume, select terrestrial broadcast/cable broadcast/satellite broadcast, or set an environment through a user input.

Further, the control apparatus 101 may be a pointing apparatus. For example, the control apparatus 101 may operate as the pointing device when receiving a specific key input.

The term “user” herein means a person who controls functions or operations of the image display apparatus 100 using the control apparatus 101, and may include a viewer, an administrator, or an install engineer.

A broadcast signal may be output from each of broadcast channels. The broadcast signal is a media signal output from a corresponding broadcast channel, and may include one or more of an image signal, a speech signal, and a text signal. The media signal may also be referred to as contents. The media signal may be stored in an internal memory (not shown) of the image display apparatus 100 or may be stored in an external server (not shown) coupled through a communication network. The image display apparatus 100 may output the media signal stored in the internal memory or may receive the media signal from the external server and output the media signal. The external server may include a server such as a terrestrial broadcasting station, a cable broadcasting station, or an Internet broadcasting station.

The media signal may include a signal that is output to the image display apparatus 100 in real time.

According to an embodiment of the disclosure, the image display apparatus 100 may output media signals of channels classified for each genre when receiving channel information from the user. For example, in FIG. 1, a user may request channel information from the image display apparatus 100 using the control apparatus 101 to view a desired media signal.

The user may request the channel information from the image display apparatus 100 by using one of the provided key, button, and touch pad. The user may request the channel information from the image display apparatus 100 by selecting information corresponding to a channel information request from among various pieces of information displayed on a screen of the image display apparatus 100 by using the control apparatus 101.

In an embodiment of the disclosure, the control apparatus 101 may be provided with a channel information request button (not shown) separately. In this case, the user may request the channel information from the image display apparatus 100 by inputting the channel information request button provided in the control apparatus 101. In an embodiment of the disclosure, the control apparatus 101 may include a button (not shown) for a multi-view function, and the user may request the channel information from the image display apparatus 100 by inputting the button for the multi-view function.

In an embodiment of the disclosure, when the control apparatus 101 includes a microphone (not shown) capable of receiving a speech, the user may generate a speech signal corresponding to the channel information request, such as “show the sports channel”. In this case, the control apparatus 101 may identify the speech signal from the user as the channel information request and transmit the speech signal to the image display apparatus 100.

In an embodiment of the disclosure, the control apparatus 101 may include a sensor (not shown) capable of receiving a motion. In this case, the user may generate a motion corresponding to the channel information request, and the control apparatus 101 may identify the motion corresponding to the channel information request and transmit the motion to the image display apparatus 100.

A broadcast channel may be distinguished as one genre according to content of a media signal included in the broadcast signal received through a current broadcast channel. For example, the broadcast channel may be classified into one of several genres such as a sports channel, a news channel, a home shopping channel, a movie channel, a drama channel, an advertisement channel, and the like according to what media signal is currently output from a certain broadcast channel.

When receiving a request for channel information from the user, the image display apparatus 100 may output information about a channel on a screen in accordance with the request. The information about the channel may be information indicating a genre for each broadcast signal received through the current broadcast channel. The user may use the control apparatus 101 to select a channel of a desired genre from the channel information output on the screen and use a media signal output from the selected channel.

In an embodiment of the disclosure, the information about the channel may include a channel classification menu 115, as in FIG. 1. The channel classification menu 115 is a menu displaying currently output media signals by genres, and the user may easily select a channel of a desired genre using the channel classification menu 115. For example, in FIG. 1, when the user wishes to view a sports channel, the user may select the sports menu from among the channel classification menu 115 displayed on a bottom of the screen by using the control apparatus 101. The image display apparatus 100 may output a plurality of broadcast signals output from broadcast channels outputting a sports broadcast among several broadcast signals currently being broadcast to a single screen, in accordance with a request of the user.

In an embodiment of the disclosure, when the channel information request of the user includes information about a specific genre, the image display apparatus 100 may directly output a media signal classified into the specific genre requested by the user. For example, when the control apparatus 101 includes the microphone capable of receiving a speech and the user generates a speech signal corresponding to the channel information request, such as “show the sports channel”, the control apparatus 101 may identify the speech signal of the user as the channel information request, and transmit the speech signal to the image display apparatus 100. The image display apparatus 100 may directly output the sports channel which is the specific channel requested by the user on the screen.

When genres corresponding to the plurality of broadcast signals received from the plurality of broadcast channels are the same, the image display apparatus 100 may output the plurality of broadcast signals received through the broadcast channels classified into the same genre to the screen in a multi-view format. A multi-view may mean a service for outputting the respective image signals output from several channels together on one screen such that the user may simultaneously view image signals output from the several channels in real time or easily select a desired channel. The user may determine media signals of several channels of the same genre output from the image display apparatus 100 at a glance and easily select a desired specific channel from among the channels.

In FIG. 1, the image display apparatus 100 outputs a four split multi-view. That is, four screens 111, 112, 113, and 114 of FIG. 1 output the respective broadcast signals of a plurality of broadcast channels which are currently outputting a sports broadcast signal on split regions of the screen in the multi-view format. The number of broadcast signals that may be output as the multi-view on one screen may be already set in the image display apparatus 100 or may be set by the user. The image display apparatus 100 may output media signals of a plurality of channels on one screen by using various methods. For example, the image display apparatus 100 may arrange the media signals of the plurality of channels in a line from the top to the bottom and output the media signals on the screen, but the disclosure is not limited thereto.

When there are many broadcast signals of the same genre that may not be displayed on one screen in the multi-view format, the image display apparatus 100 may output the channel classification menu 115 including a plurality of menus for selecting channels of the genre. In FIG. 1, for example, when the multi-view is set to a 4 split screen, and eight broadcast channels output sports broadcaststhe channel classification menu 115 may include a plurality of sports menus such as sports 1 and sports 2 menus as shown in FIG. 1. The user may select a desired menu from sports 1 and sports 2 menus included in the channel classification menu 115 to select a desired sports broadcasting signal.

In an embodiment of the disclosure, the image display apparatus 100 may output all the channels classified in the same genre on one screen in the multi-view form. For example, when eight broadcast channels output sports broadcasts, the image display apparatus 100 may split the screen into eight regions and output the eight sports genre channels to the respective regions of the 8 split screen.

FIG. 2 is a block diagram illustrating a configuration of a computing apparatus 200 according to an embodiment of the disclosure.

The computing apparatus 200 shown in FIG. 2 may be an embodiment of the image display apparatus 100 shown in FIG. 1. The computing apparatus 200 may be included in the image display apparatus 100 and receive a channel information request from a user and generate and output information about a genre of a broadcast signal received from each of a plurality of channels, in accordance with the channel information request from a user.

In another embodiment of the disclosure, the computing apparatus 200 may be an apparatus included in a server (not shown) separate from the image display apparatus 100. The server may be an apparatus capable of transmitting certain content to the computing apparatus 200, and may include a broadcast station server, a content provider server, a content storage apparatus, and the like. In this case, the computing apparatus 200 may be connected to the image display apparatus 100 through a communication network, receive the channel information request of a user through the communication network, generate information about a channel in accordance with the request of the user and transmit the information to the image display apparatus 100. The image display apparatus 100 may output the information about the channel received from the computing apparatus 200 and show the information to the user.

Hereinafter, both the case where the computing apparatus 200 of FIG. 2 is included in the image display apparatus 100 and the case where the computing apparatus 200 is included in an external server separate from the image display apparatus 100 will be described together.

Referring to FIG. 2, the computing apparatus 200 according to an embodiment of the disclosure may include a memory 210 and a processor 220.

The memory 210 according to an embodiment of the disclosure may store programs for processing and control of the processor 220. The memory 120 may include at least one type storage medium of a flash memory type, a hard disk type, a multimedia card micro type, a card type memory (e.g., SD or XD memory, etc.), random access memory (RAM), static random access memory (SRAM), read only memory (ROM), electrically erasable programmable read-only memory (EEPROM), programmable read-only memory (PROM), a magnetic memory, a magnetic disk, or an optical disk.

The processor 220 may store data that is input to or output from the computing apparatus 200. The processor 220 according to an embodiment of the disclosure may determine a genre of a media signal output in real time on a channel, by using a learning model using one or more neural networks.

The processor 220 according to an embodiment of the disclosure may obtain metadata that displays information about the media signal, together with the media signal, or in a signal separate from the media signal. The metadata is attribute information for representing the media signal, and may include one or more of a location, content, use condition, and index information of the media signal. The processor 220 may obtain genre information from the metadata. The genre information may include information guiding a genre of a broadcast signal broadcasted on a certain broadcast channel at a certain time. The genre information may include electronic program guide (EPG) information. The EPG information is program guide information and may include a broadcast signal in the broadcast channel, that is, one or more of a time and content at which content is output, performer information, and a genre of the content. The memory 210 may store genre information with respect to the media signal.

Because the genre information includes information about broadcast signals received the respective broadcast channels, the user may determine the genre of content output from a channel by using the genre information. The user may determine which genre of content is output from each channel for each time by using a list displaying the genre information, etc.

However, content actually output from a current channel may not be the same as a genre informed from the genre information. For example, the genre information may indicate that a movie is output from channel 9 at a certain time, but the movie is not actually output from channel 9 at the certain time, and an advertisement inserted in the middle of the movie may be output. Alternatively, the movie may be already output from channel 9, and content supposed to be output next to the movie may be output a little sooner. Alternatively, due to various causes, a genre, etc. such as news, other than the movie, may be output from the channel. Therefore, the user may not accurately know a content genre of the channel currently output in real time by using only the genre information.

Accordingly, the computing apparatus 200 according to an embodiment of the disclosure may determine whether the content genre of the channel currently output in real time is identical to the genre information by using a speech signal output from the channel together with the genre information.

The processor 220 according to an embodiment of the disclosure may obtain the speech signal among a media signal output from each of a plurality of channels in real time. The processor 220 may convert the speech signal into a text signal. The processor 220 may determine whether the speech signal included in the media signal is a human utterance, and convert the speech signal into the text signal only when the speech signal is the human utterance.

The processor 220 may obtain a keyword from the converted text signal. The processor 220 according to an embodiment of the disclosure may determine whether a keyword is a word that is helpful in determining the genre of the channel when obtaining the keyword from the text signal, and then extract the keyword that is determined to be helpful in determining the genre of the channel. The processor 220 according to an embodiment of the disclosure may obtain a keyword from a subtitle that is reproduced together with the speech signal. When the speech signal is a foreign language, the processor 220 may obtain the keyword by receiving the subtitle corresponding to the content output from the channel from a server. The processor 220 may use the subtitle only to obtain the keyword therefrom without using the speech signal. Alternatively, the processor 220 may translate the speech signal into a native language, convert the speech signal into the text signal, and obtain the keyword from the text signal. Alternatively, the processor 220 may obtain the keyword by using the subtitle and the text signal generated by translating the speech signal into the native language.

The memory 210 may store the keyword obtained from the speech signal. The processor 220 may execute one or more instructions to obtain a keyword corresponding to each broadcast channel from a speech signal included in one or more broadcast channel signals, by using a learning model using one or more neural networks, determine a genre corresponding to each of the one or more broadcast channel signals, by using genre information obtained from metadata about the one or more broadcast channel signals and the keyword corresponding to each broadcast channel, and provide information about the one or more broadcast channel signals, by using the determined genre with respect to each of the one or more broadcast channel signals.

Because an amount of data to be processed of the speech signal is not greater than that of an image signal, when the genre of the channel is determined using the speech signal, the genre of the channel may be determined by using an amount of data of the speech signal smaller than that of the image signal. Further, in an embodiment of the disclosure, the processor 220 may determine the genre of the channel by using the keyword obtained from the speech signal, rather than using the speech signal itself, thereby determining the genre of the channel using only a small amount of data.

The computing apparatus 200 may quickly determine the genre of the channel by using the speech signal having a relatively small amount of data than the image signal. In addition, the computing apparatus 200 may use the speech signal together with genre information, thereby more accurately determining the content genre of the channel output in real time.

In an embodiment of the disclosure, the processor 220 may obtain a speech signal from one or more broadcast channel signals at a set period and obtain a keyword corresponding to each broadcast channel from the obtained speech signal.

Therefore, the computing apparatus 200 may determine a genre corresponding to a channel by using a keyword of a channel signal updated every certain period, thereby more accurately determining a genre of the channel signal that changes in real time.

In an embodiment of the disclosure, the processor 220 may determine a similarity between the keyword and the genre information by using a neural network. The processor 220 may perform an operation on the obtained keyword to obtain a probability value for each genre.

For example, the processor 220 may perform the operation on the keyword to determine a genre closer to a genre of a broadcast channel that outputs a broadcast signal of the obtained keyword among genres. The processor 220 may determine the genre closer to the genre of the broadcast signal of the obtained keyword as the probability value for each genre. For example, the processor 220 may obtain a probability value that the genre of the broadcast signal is a sports genre, a probability value that the genre of the broadcast signal is a drama genre, a probability value that the genre of the broadcast signal is an advertisement genre, and the like. It is assumed that the probability values of the broadcast signals obtained by the processor 220 for each genre are 87%, 54%, and 34% with respect to sports, drama, and advertisement, respectively.

The processor 220 may determine whether a probability value that the genre of the broadcast channel is a genre according to genre information extracted from metadata exceeds a certain threshold value. The genre information extracted from the metadata indicates the genre of the broadcast signal received through the channel at a certain time. For example, when the genre information extracted from the metadata indicates that the genre of the broadcast channel is currently sports, the processor 220 may determine whether the probability value that the genre of the broadcast signal is the sports genre exceeds a certain threshold value. For example, when the certain threshold value is set to 80%, because the probability value that the genre of the broadcast signal is the sports genre is 87%, which exceeds the certain threshold value of 80%, the processor 220 may determine the genre of the broadcast channel according to the genre information of the metadata.

When the probability value that the genre of the broadcast signal is a genre according to the genre information extracted from the metadata does not exceed the certain threshold value, the processor 220 may determine that the genre of the broadcast signal is not the genre according to the genre information. For example, in the above example, when the genre information extracted from the metadata indicates that the genre of the broadcast channel is the drama, the processor 220 may determine whether the probability value that the genre of the broadcast signal is the drama genre exceeds the certain threshold value. The probability value that the genre of the broadcast signal is the drama genre is 54%, which does not exceed the certain threshold value of 80%, and thus the processor 220 may determine that the genre information is not the genre of the broadcast channel.

In an embodiment of the disclosure, the processor 220 may convert the keyword and the genre information into a numerical vector of a certain dimension to determine the similarity between the obtained keyword and the genre information. For example, the processor 220 may convert both the keyword and the genre information into a two-dimensional numerical vector. Alternatively, the processor 220 may convert both the keyword and the genre information into a three-dimensional numerical vector. The processor 220 may determine relation of the converted numerical vectors. The processor 220 may determine whether relation between the numerical vector converted from the keyword and the numerical vector converted from the genre information is high. When the relation of the two numerical vectors is high, the processor 220 may determine the genre of the channel according to the genre information. Generally, because the genre information includes schedule information of content output from the channel for each time, when determining that the numerical vector relation of the keyword and the genre information exceeds the certain threshold value, the processor 220 may determine a genre of a channel signal output from a current channel by using the genre of the channel indicated in the genre information. When determining that the relation of the converted numerical vectors is not high, the processor 220 may determine that a genre of a certain channel indicated in the genre information is not the same as a genre of content currently output from the certain channel

In an embodiment of the disclosure, when determining that the relation between the genre information of the broadcast channel and the keyword is not high, the processor 220 may determine the genre of the channel by using an image signal of the channel.

When the probability value that the genre of the broadcast signal is the genre according to the genre information extracted from the metadata does not exceed the certain threshold value or when the numerical vector relation of the keyword and the genre information does not exceed the certain threshold value, the processor 220 may obtain an image signal of the broadcast signal. The processor 220 may obtain an image signal output together with a speech signal at the same time from the same broadcast channel. The processor 220 may determine the genre of the channel by using the keyword obtained from the speech signal and stored in the memory 210 together with the obtained image signal.

In an embodiment of the disclosure, the processor 220 may execute one or more instructions stored in the memory 210 to control the above-described operations to be performed. In this case, the memory 210 may store one or more instructions executable by the processor 220.

In an embodiment of the disclosure, the processor 220 may store one or more instructions in a memory (not shown) provided in the processor 220 and may execute the one or more instructions stored in the memory therein to control the above-described operations to be performed. That is, the processor 220 may execute at least one instruction or program stored in an internal memory provided in the processor 220 or the memory 210 to perform a certain operation.

Also, in an embodiment of the disclosure, the processor 220 may include a graphic processing unit (not shown) for graphic processing corresponding to a video. A processor (not shown) may be implemented as a system on chip (SoC) incorporating a core (not shown) and a GPU (not shown). The processor (not shown) may include a single core, a dual core, a triple core, a quad core, and multiple cores thereof.

The memory 210 according to an embodiment of the disclosure may store a keyword extracted from a speech signal output by the processor 220 from each channel for each channel. The memory 210 may store information about a time at which the speech signal from which the processor 220 extracts each keyword is output together with the keyword. In addition, the memory 210 may store an image signal output from the channel within a certain time from the time at which the speech signal is output. When the processor 220 determines a genre corresponding to each channel, the memory 210 may store corresponding genre information for each channel, classify channels for each same genre, and store information about the channels classified for each same genre.

The processor 220 may control the overall operation of the computing apparatus 200. For example, the processor 220 may execute one or more instructions stored in the memory 210 to perform a function of the computing apparatus 200.

Although FIG. 2 illustrates one processor 220, the computing apparatus 200 may include a plurality of processors (not shown). In this case, each of operations performed by the computing apparatus 200 according to an embodiment of the disclosure may be performed through at least one of the plurality of processors.

The processor 220 according to an embodiment of the disclosure may extract a keyword from a speech signal by using a learning model using one or more neural networks, and determine a genre of a channel by using the keyword and genre information.

In an embodiment of the disclosure, the computing apparatus 200 may use an artificial intelligence (AI) technology. AI technology refers to machine learning (deep learning) and element technologies that utilize the machine learning.

Machine learning is an algorithm technology that classifies/learns the features of input data autonomously. Element technology is a technology that simulates the functions of the human brain such as recognition and judgment by utilizing machine learning algorithm such as deep learning and consists of technical fields such as linguistic understanding, visual comprehension, reasoning/prediction, knowledge representation, and motion control.

AI technology is applied to various fields as follows. Linguistic understanding is a technology to identify and apply/process human language/characters and includes natural language processing, machine translation, dialogue systems, query response, speech recognition/synthesis, and the like. Visual comprehension is a technology to identify and process objects like human vision and includes object recognition, object tracking, image search, human recognition, scene understanding, spatial understanding, image enhancement, and the like. Reasoning prediction is a technology to acquire and logically infer and predict information and includes knowledge/probability based reasoning, optimization prediction, preference based planning, recommendation, and the like. Knowledge representation is a technology to automate human experience information into knowledge data and includes knowledge building (data generation/classification), knowledge management (data utilization), and the like. Motion control is a technology to control autonomous traveling of a vehicle and motion of a robot, and includes motion control (navigation, collision avoidance, and traveling), operation control (behavior control), and the like.

In an embodiment of the disclosure, the neural network may be a set of algorithms that learn a method of determining a channel from a certain media signal input to the neural network based on AI. For example, the neural network may learn a method of determining a genre of a channel from the media signal, based on supervised learning using the certain media signal as an input value, and unsupervised learning finding a pattern for determining the genre of the channel from the media signal by learning a type of data necessary for determining the genre of the channel from the media signal for itself without any supervising. Further, for example, the neural network may learn the method of determining the genre of the channel from the media signal by using reinforcement learning using feedback on correctness of a result of determining the genre based on learning.

Also, the neural network may perform an operation for reasoning and prediction according to the AI technology. Specifically, the neural network may be a deep neural network (DNN) that performs the operation through a plurality of layers. The neural network may be classified into the DNN when the number of layers is plural according to the number of internal layers performing operations, that is, when a depth of the neural network performing the operation increases. In addition, a DNN operation may include a convolution neural network (CNN) operation, etc. That is, the processor 220 may implement a data determination model for distinguishing genres through an example of the neural network, and train the implemented data determination model by using learning data. Then, the processor 220 may analyze or classify input media signal and keyword using the trained data determination model, thereby analyzing and classifying a genre of the media signal.

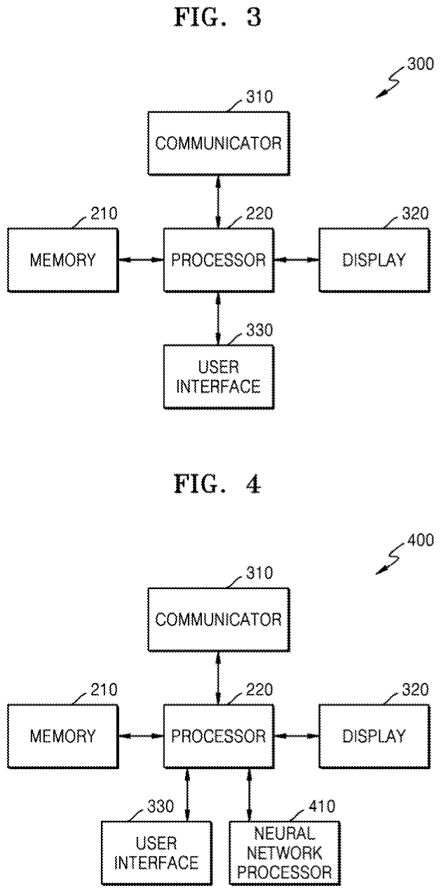

FIG. 3 is a block diagram illustrating a configuration of a computing apparatus 300 according to another embodiment of the disclosure.

The computing apparatus 300 shown in FIG. 3 may be an example of the image display apparatus 100 shown in FIG. 1. The computing apparatus 300 may be included in the image display apparatus 100 and classify media signals that are output for each channel for each genre, and output a channel for each genre, in response to a channel information request from a user.

The computing apparatus 300 shown in FIG. 3 may be an apparatus including the computing apparatus 200 of FIG. 2. Thus, the computing apparatus 300 of FIG. 3 may include the memory 210 and the processor 220 that are included in the computing apparatus 200 of FIG. 2. In the description of the computing apparatus 300, a description that is the same as in FIGS. 1 and 2 will be omitted.

Referring to FIG. 3, the computing apparatus 300 shown in FIG. 3 may further include a communicator 310, a display 320, and a user interface 330, in comparison with the computing apparatus 200 shown in FIG. 2.

The computing apparatus 200 300 may determine and output a genre of a channel by using a speech signal output for each channel in response to a channel information request from a user.

The communicator 310 may communicate with an external apparatus (not shown) through a wired/wireless network. Specifically, the communicator 310 may transmit and receive data to and from the external apparatus (not shown) connected through the wired/wireless network under the control of the processor 220. The external apparatus may be a server, an electronic apparatus, or the like that supplies content provided through the display 320. For example, the external apparatus may be a broadcast station server, a content provider server, a content storage apparatus, or the like that may transmit certain content to the computing apparatus 300.

In an embodiment of the disclosure, the computing apparatus 300 may receive a plurality of broadcast channels from the external apparatus through the communicator 310. In addition, the computing apparatus 300 may receive metadata which is attribute information of a broadcast signal for each channel from the external apparatus through the communicator 310.

The communicator 310 may communicate with the external apparatus through the wired/wireless network to transmit/receive signals. The communicator 310 may include at least one communication module such as a near field communication module, a wired communication module, a mobile communication module, a broadcast receiving module, or the like. Here, the at least one communication module may be a communication module capable of performing data transmission/reception through a network conforming to a communication specification such as a tuner, a Bluetooth, a Wireless LAN (WLAN)(Wi-Fi), a Wireless Broadband (Wibro), World Interoperability for Microwave Access (Wimax), CDMA, WCDMA, etc. that perform broadcast reception.

The display 320 may output a broadcast channel signal received through the communicator 310.

In an embodiment of the disclosure, the display 320 may output information about one or more broadcast channels, in response to a channel information request from a user.

Accordingly, the user may easily determine channels that broadcast a genre to be watched, and may easily select and use a desired channel from among the channels of the genre to be watched.

The information about the broadcast channel may include the channel classification menu 115 of FIG. 1. The display 320 may receive one genre selected from the channel classification menu 115 from the user, and may output channels classified as the genre requested by the user in response thereto.

In an embodiment of the disclosure, when genres corresponding to the plurality of broadcast channels are the same, the display 320 may output a plurality of image signals included in the plurality of broadcast channels corresponding to the same genre in a multi-view format.

Accordingly, the user may determine media signals of several channels of the same genre output from the display 320 at a glance.

In an embodiment of the disclosure, when the genres corresponding to the plurality of broadcast channels are the same, the display 320 may output the plurality of image signals included in the plurality of broadcast channels corresponding to the same genre based on priorities according to one or more of a viewing history and a viewing rating of the user. That is, when determining priorities, storing the priorities in the memory 210, and then outputting a plurality of channels, by using the viewing history or the viewing rating of the user, the computing apparatus 300 may sequentially output the channels from image signals of high priority channels. The display 320 may output channels from the high priority channels in the order of an upper left, a lower left, an upper right, and a lower right of a 4 split multi-view, but the disclosure is not limited thereto. Alternatively, the display 320 may split a screen into a plurality of regions from top to bottom and output a plurality of channel signals from the high priority channels by positioning the channels at an upper region of the screen.

When the display 320 is implemented as a touch screen, the display 320 may be used as both an output apparatus and an input apparatus. For example, the display 320 may include at least one of a liquid crystal display, a thin film transistor-liquid crystal display, an organic light-emitting diode, a flexible display, a 3D display, or an electrophoretic display. According to an implementation type of the computing apparatus 300, the computing apparatus 300 may include two or more displays 320.

The user interface 330 may receive a user input for controlling the computing apparatus 300. The user interface 330 may include a user input device including a touch panel that senses a touch of the user, a button that receives a push operation of the user, a wheel that receives a rotation operation of the user, a key board, a dome switch, etc. but the disclosure is not limited thereto. In addition, when the computing apparatus 300 operates by a remote controller (not shown), the user interface 330 may receive a control signal from the remote controller (not shown).

In an embodiment of the disclosure, the user interface 330 may receive a user input corresponding to a channel information request from the user. The channel information request may be a specific button input, a speech signal of the user, a specific motion, or the like. The user interface 330 may also receive a user input that selects a menu included in the channel classification menu 115 when the display 320 outputs the channel classification menu 115.

FIG. 4 is a block diagram illustrating a configuration of a computing apparatus 400 according to another embodiment of the disclosure.

FIG. 4 may include the configuration of FIG. 3. Therefore, the same configurations as those in FIG. 3 are denoted by the same reference numerals. In the description of the computing apparatus 400, a description that is the same as in FIGS. 1 to 3 will be omitted.

Referring to FIG. 4, the computing apparatus 400 shown in FIG. 4 may further include a neural network processor 410, in comparison with the computing apparatus 300 shown in FIG. 3. That is, the computing apparatus 400 of FIG. 4 may perform an operation through a neural network through the neural network processor 410 which is a processor separate from the processor 220, unlike the computing apparatus 300 of FIG. 3.

The neural network processor 410 may perform an operation through the neural network. Specifically, in an embodiment of the disclosure, the neural network processor 410 may execute one or more instructions to perform the operation through the neural network.

Specifically, the neural network processor 410 may perform the operation through the neural network to determine a genre corresponding to a channel by using a speech signal output from the channel. The neural network processor 410 may convert the speech signal into a text signal and obtain a keyword from the text signal. The neural network processor 410 may obtain the speech signal for each channel every certain period and obtain the keyword therefrom. The neural network processor 410 may convert the speech signal into the text signal only when the speech signal output from the channel is a human utterance.

To compare the keyword with genre information, the neural network processor 410 may perform an operation on the keyword to calculate a probability value for each genre and determine whether a probability value that a genre of a broadcast signal is a genre according to the genre information exceeds a certain threshold value. In an embodiment of the disclosure, the neural network processor 410 may convert each of the keyword and the genre information into a numerical vector, determine a degree of similarity of the numerical vector with respect to the keyword and the numerical vector with respect to the genre information, and when relation of the numerical vectors is determined to be high, determine the genre of the broadcast channel based on the genre information.

When the probability value that the genre of the broadcast signal is the genre according to the genre information does not exceed the certain threshold value or when the relation of the numerical vectors of the keyword and the genre information is not high, the neural network processor 410 may obtain an image signal output together with a speech signal at a time when the speech signal is output from a channel from which the speech signal is output. The neural network processor 410 may analyze the image signal together with the keyword obtained from the speech signal to determine a genre of content output from the channel. The neural network processor 410 may classify channels according to the determined genre of the channel, and output the classified channels according to the genre through the display 320.

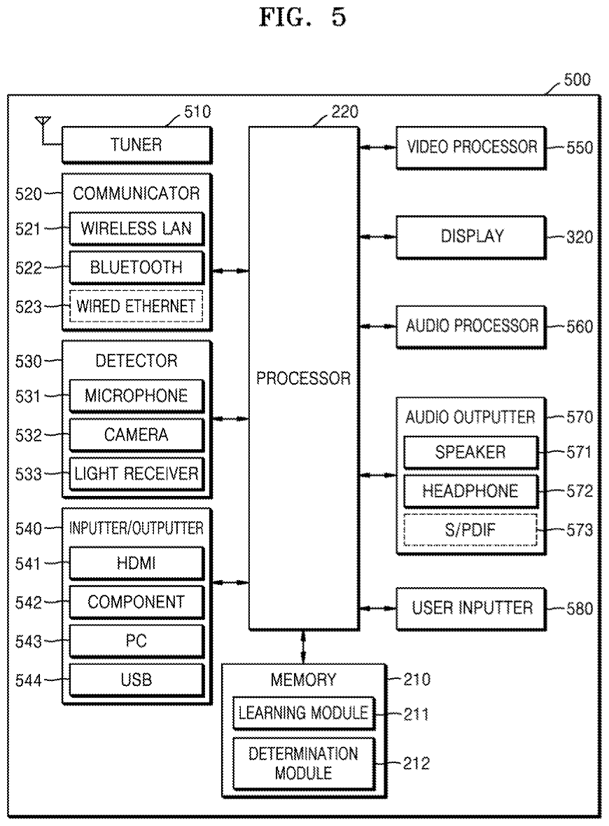

FIG. 5 is a block diagram illustrating a configuration of a computing apparatus 500 according to another embodiment of the disclosure.

As shown in FIG. 5, the computing apparatus 500 may include a tuner 510, a communicator 520, a detector 530, an inputter/outputter 540, a video processor 550, an audio processor 560, an audio outputter 570, and a user inputter 580, in addition to the memory 210, the processor 220, and the display 320.

The same descriptions of the memory 210, the processor 220, and the display 320 as those in FIGS. 2 and 3 will be omitted in FIG. 5. Also, the communicator 310 described in FIG. 3 may correspond to at least one of the tuner 510 or the communicator 520. Also, the user inputter 580 of the computing apparatus 500 may include the configuration corresponding to the control apparatus 101 of FIG. 1 or the user interface 330 described in FIG.

3.

Thus, in the description of the computing apparatus 500 shown in FIG. 5, a description that is the same as in FIGS. 1 to 4 will be omitted.

The tuner 510 may tune and select a frequency of a channel that a user wants to receive via the computing apparatus 500, wherein the frequency is obtained by tuning, via amplification, mixing, and resonance, frequency components of a media signal that is received in a wired or wireless manner. The media signal may include a broadcast signal, and the media signal may include one or more of audio, video that is an image signal, and additional information such as metadata. The metadata may include genre information. The media signal may also be referred to as a content signal.

The content signal received through the tuner 510 may be decoded (for example, audio decoding, video decoding, or additional information decoding) and separated into audio, video and/or additional information. The separated audio, video and/or additional information may be stored in the memory 210 under the control of the processor 220.

The tuner 510 of the computing apparatus 500 may be one or plural. The tuner 510 may be implemented as an all-in-one with the computing apparatus 500 or may be a separate apparatus (e.g., a set-top box) having a tuner that is electrically connected to the computing apparatus 500, and a tuner (not shown) connected to the inputter/outputter 540.

The communicator 520 may connect the computing apparatus 500 to an external apparatus (e.g., an external server or an external apparatus, etc.) under the control of the processor 220. The processor 220 may transmit/receive content to/from the external apparatus connected through the communicator 520, download an application from the external apparatus, or perform web browsing.

The communicator 520 may include one of wireless LAN, Bluetooth, and wired Ethernet according to a performance and a structure of the computing apparatus 500. The communicator 520 may include a combination of wireless LAN, Bluetooth, and wired Ethernet. The communicator 520 may receive a control signal of the control apparatus 101 under the control of the processor 220. The control signal may be implemented as a Bluetooth type, an RF signal type, or a WiFi type.

The communicator 520 may further include a near field communication (for example, near field communication (NFC), (not shown) and a Bluetooth low energy (not shown) other than Bluetooth.

According to an embodiment of the disclosure, the communicator 520 may receive a learning model using one or more neural networks from an external server (not shown). The communicator 520 may receive information about a broadcast channel from the external server. The information about a broadcast channel may include information indicating a genre corresponding to each of broadcast channels. The communicator 520 may receive the information about the broadcast channel from the external server every set period or whenever a request is received from the user.

The detector 530 may detect a speech of the user, an image of the user, or an interaction of the user and include a microphone 531, a camera 532, and a light receiver 533.

The microphone 531 receives an uttered speech of the user. The microphone 531 may convert the received speech into an electric signal and output the electric signal to the processor 220. In an embodiment of the disclosure, the microphone 531 may receive a speech signal corresponding to a channel information request from the user.

The camera 532 may receive an image (e.g., a continuous frame) corresponding to a motion of the user including a gesture within a camera determination range. The camera 532 according to an embodiment of the disclosure may receive from the control apparatus 101 a motion corresponding to the channel information request from the user.

The light receiver 533 receives a light signal (including a control signal) received from the control apparatus 101. The light receiver 533 may receive the light signal corresponding to a user input (e.g., touch, press, touch gesture, speech, or motion) from the control apparatus 101. The control signal may be extracted from the received light signal under the control of the processor 220. The light receiver 533 according to an embodiment of the disclosure may receive the light signal corresponding to the channel information request from the user, from the control apparatus 101.

The inputter/outputter 540 receives video (e.g., a moving image, a still image signal, or the like), audio (e.g., a speech signal, a music signal, or the like) and additional information (e.g., genre information, etc.) from outside the computing apparatus 500 under the control of the processor 220. The inputter/outputter 540 may include one of a high-definition multimedia interface (HDMI) port 541, a component jack 542, a PC port 543, and a USB port 544. The inputter/outputter 540 may include a combination of the HDMI port 541, the component jack 542, the PC port 543, and the USB port 544.

The memory 210 according to an embodiment of the disclosure may store programs for processing and controlling of the processor 220 and store data input to or output from the computing apparatus 500. Also, the memory 210 may store various data necessary for an operation of the computing apparatus 500.

The programs stored in the memory 210 may be classified into a plurality of modules according to their functions. Specifically, the memory 210 may store one or more programs for performing a certain operation by using a neural network. For example, one or more programs stored in the memory 210 may be classified into a learning module 211, a determination module 212, and the like.

The learning module 211 may include a learning model determined by learning a method of obtaining a keyword from a plurality of channel speech signals in response to input of a plurality of speech signals for each channel into one or more neural networks, comparing the keyword with genre information, and determining a genre of a channel. The learning module 211 may also include a learning model determined by learning a method of obtaining an image signal reproduced together with a speech signal when relation of the keyword and the genre information exceeds a certain threshold value, and determining the genre of the channel by using the image signal and the keyword. The learning model may be received from an external server and the received learning model may be stored in the learning module 211.

The determination module 212 may store a program that causes the processor 220 to execute one or more instructions to determine an actual genre of a media signal by using the media signal output from the channel. In addition, when the processor 220 determines a genre for each channel, the determination module 212 may store information about the determined genre of the channel.

In addition, one or more programs for performing certain operations using the neural network, or one or more instructions for performing certain operations using the neural network may be stored in an internal memory (not shown) included in the processor 220.

The processor 220 controls the overall operation of the computing apparatus 500 and the flow of a signal between internal components of the computing apparatus 500 and processes data. When a user input is received or a stored pre-set condition is satisfied, the processor 220 may execute an operating system (OS) and various applications stored in the memory 210.

The processor 220 according to an embodiment of the disclosure may execute one or more instructions stored in the memory 210 to determine the actual genre of the media signal output from the channel from the media signal output from the channel by using the learning model using one or more neural networks.

In addition, the processor 220 may include an internal memory (not shown). In this case, at least one of data, programs, or instructions stored in the memory 210 may be stored in the internal memory (not shown) of the processor 220. For example, the internal memory (not shown) of the processor 220 may store the one or more programs for performing certain operations using the neural network, or the one or more instructions for performing certain operations using the neural network.

The video processor 550 may perform image processing to be displayed by the display 320 and perform various image processing operations such as decoding, rendering, scaling, noise filtering, frame rate conversion, resolution conversion, and the like on the image data.

The display 320 may display, on the screen, an image signal included in a media signal such as a broadcast signal received through the tuner 510 under the control of the processor 220. In addition, the display 320 may display content (e.g., a moving image) input through the communicator 520 or the inputter/outputter 540. The display 320 may output an image stored in the memory 210 under the control of the processor 220.

The audio processor 560 performs processing on audio data. The audio processor 560 may perform various kinds of processing such as decoding and amplification, noise filtering, and the like on the audio data.

The audio outputter 570 may output audio included in the broadcast signal received through the tuner 510, audio input through the communicator 520 or the inputter/outputter 540, and audio stored in the memory 210 under the control of the processor 220. The audio outputter 570 may include at least one of a speaker 571, a headphone output terminal 752, or a Sony/Philips Digital Interface (S/PDIF) output terminal 573.

The user inputter 580 is means for a user to input data for controlling the computing apparatus 500. For example, the user inputter 580 may include a key pad, a dome switch, a touch pad, a jog wheel, a jog switch, and the like, but is not limited thereto.

The user inputter 580 may be a component of the control apparatus 101 or the user interface 330 described above.

The user inputter 580 according to an embodiment of the disclosure may receive a request for channel information of the genre of the channel. In addition, the user inputter 580 may receive a selection of a specific channel from the channel classification menu 115.

Meanwhile, the block diagrams of the computing apparatuses 200, 300, 400, and 500 shown in FIGS. 2 through 5 are block diagrams for an embodiment of the disclosure. Each component of the block diagrams may be integrated, added, or omitted according to the specifications of an actually implemented computing apparatus. For example, when necessary, two or more components may be combined into one component, or one component may be divided into two or more components. In addition, a function performed in each block is intended to explain embodiments of the disclosure, and the specific operation or apparatus does not limit the scope of the disclosure.

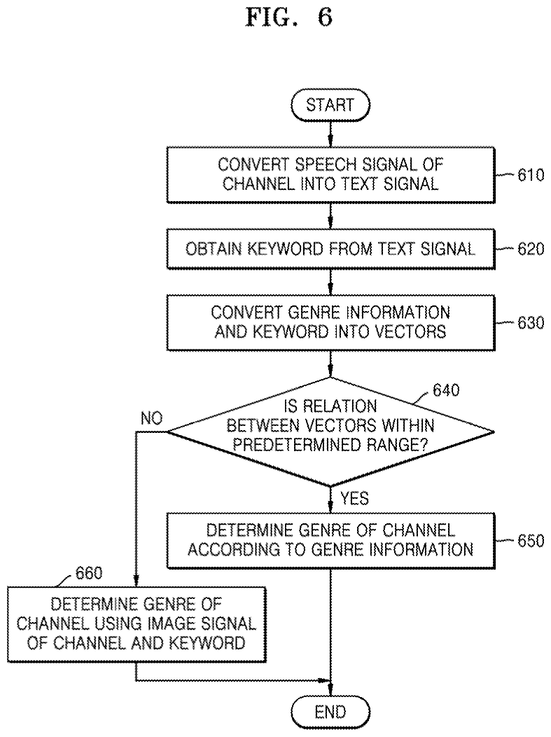

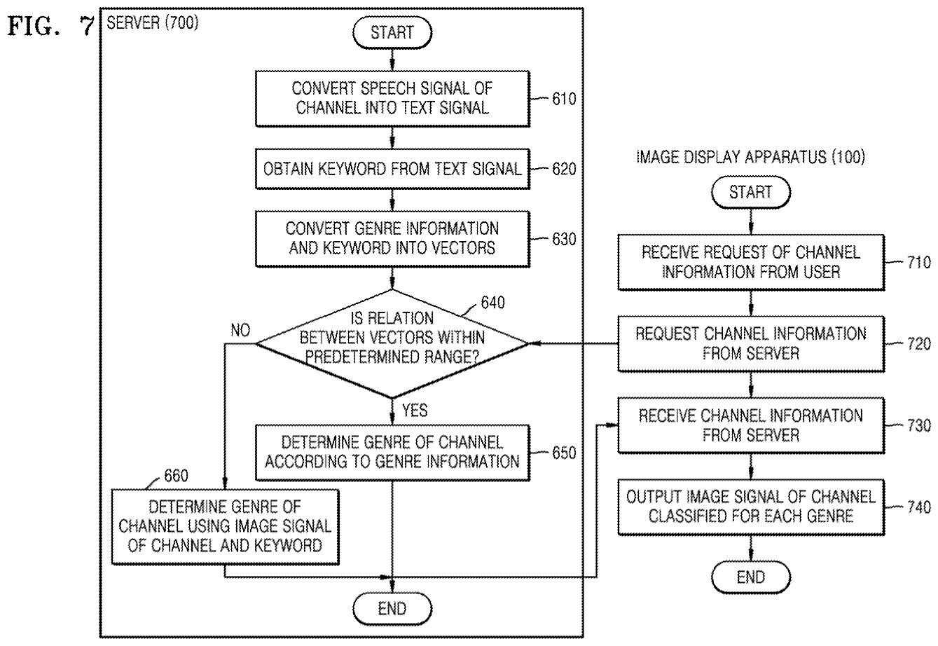

FIG. 6 is a flowchart illustrating a method of determining a genre of a channel, according to an embodiment of the disclosure.

Referring to FIG. 6, the computing apparatus 200 may obtain speech included in a channel signal for each of a plurality of broadcast channel signals. The computing apparatus 200 may convert a speech signal of the channel into a text signal (operation 610). The computing apparatus 200 may determine whether the speech signal is a human utterance, and convert the speech signal into the text signal when the speech signal is the human utterance. The computing apparatus 200 may obtain the speech signal from each channel and convert the obtained speech signal into the text signal for each set period.

The computing apparatus 200 may obtain a keyword from the text signal (operation 620). The computing apparatus 200 may obtain the keyword that is helpful in determining the genre of the channel from the text signal. When the speech signal is a foreign language, the computing apparatus 200 may receive a subtitle corresponding to content output from the channel from an external server and obtain the keyword from the subtitle. In this case, the computing apparatus 200 may directly obtain the keyword from the subtitle output together with the speech signal instead of the speech signal.

The computing apparatus 200 may obtain genre information from metadata with respect to the media signal. The computing apparatus 200 may convert each of the genre information and the keyword into a numerical vector in the form of a multidimensional vector indicating a genre relation (operation 630). The genre information and the keyword may be converted into numerical vectors of the same dimension. For example, both the genre information and the keyword may be converted into two-dimensional vector values. The computing apparatus 200 may map two numerical vectors to points on a two-dimensional graph.

The computing apparatus 200 may compare the numerical vectors obtained with respect to the genre information and the keyword to determine similarity of two values (operation 640). The computing apparatus 200 may determine the similarity of the two numerical vectors by measuring a distance between two points, or by using a clustering model or the like. When the relation of the two numerical vectors is high, the computing apparatus 200 may determine that the genre of the channel from which the speech signal is output is identical to a genre indicated in the genre information, and determine the genre of the channel as the genre of the genre information (operation 650).

When the similarity of the two numerical vectors is not high, i.e., when the similarity is determined to go beyond a certain threshold value, the computing apparatus 200 may obtain an image signal output together with the speech signal from the channel. The computing apparatus 200 may determine the genre of the channel by using the image signal and the keyword (operation 660). The computing apparatus 200 may receive the keyword obtained from the image signal, that is, an image and the speech signal, determine a genre closer to the keyword, and determine and output the genre corresponding to the channel.

FIG. 7 is a flowchart illustrating a method of determining a genre of a channel performed by the computing apparatus 200 and the image display apparatus 100 when the computing apparatus 200 is included in an external server 700, according to an embodiment of the disclosure.

Referring to FIG. 7, the server 700 may be configured separately from the image display apparatus 100. The server 700 may generate channel genre information in response to a request from the image display apparatus 100 and may transmit the generated channel genre information to the image display apparatus 100.

In FIG. 7, a user may request channel information from the image display apparatus 100 to view a desired channel (operation 710). When the user turns on the image display apparatus 100, the image display apparatus 100 may notice that the user will select a channel, and identify the users' turning on as a channel information request. Alternatively, when the user inputs a specific button, for example, a multi-view function button, the image display apparatus 100 may identify the input of the specific button as the channel information request. Alternatively, the image display apparatus 100 may identify a speech signal of the user or a specific motion as the channel information request.

The image display apparatus 100 may request channel information from the server 700 (operation 720).

The computing apparatus 200 included in the server 700 may obtain a speech signal output from the channel for each channel and convert the speech signal into a text signal for each set period (operation 610), obtain a keyword from the text signal (operation 620), and then convert genre information and the keyword into numerical vectors (operation 630).

When the computing apparatus 200 receives the channel information request from the image display apparatus 100, the computing apparatus 200 may compare the numerical vectors of the genre information and the keyword in response to the request. When similarity of the two numerical vectors is high, the computing apparatus 200 may determine the genre of the channel according to the genre information (operation 650), and when the similarity of the two numerical vectors is not high, the computing apparatus 200 may determine the genre of the channel by using the image signal and the keyword (operation 660). The server 700 may transmit the channel information including information about the genre of the channel to the image display apparatus 100 (operation 730). After receiving the channel information from the server 700, the image display apparatus 100 may output speech signal of the channel classified for each genre (operation 740).

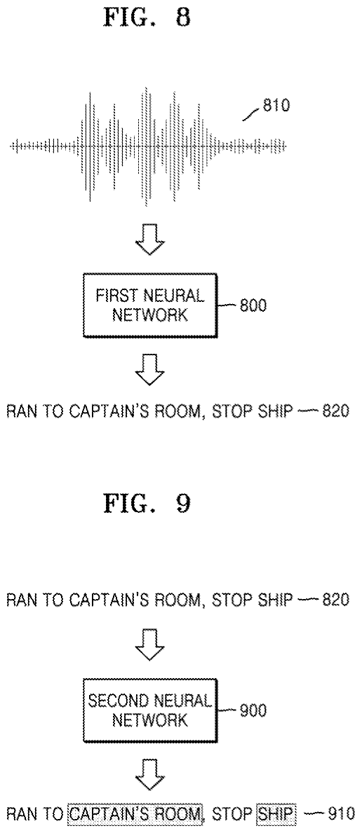

FIG. 8 is a diagram for explaining the computing apparatus 200 for obtaining a text signal 820 from a speech signal 810 according to an embodiment of the disclosure.

Referring to FIG. 8, the computing apparatus 200 may obtain the speech signal 810 included in one or more broadcast channel signals. In FIG. 8, the speech signal 810 is indicated as amplitude with respect to time. The computing apparatus 200 may convert the speech signal 810 into the text signal 820 using a first neural network 800.

The first neural network 800 according to an embodiment of the disclosure may be a model trained to receive a speech signal and output a text signal corresponding to the speech signal. The first neural network 830 may determine whether the speech signal 810 is a human utterance, and may convert the speech signal 810 into the text signal 820 when the speech signal is the human utterance. That is, the first neural network 830 may be the model trained to select and identify only the human utterance from among audio.

Accordingly, the first neural network 830 may determine a genre of a channel more accurately by using the human utterance. In addition, the first neural network 830 may use only the human utterance as an input signal, thereby reducing resources required for data operation.

In an embodiment of the disclosure, the first neural network 800 may determine whether the speech signal 810 is a foreign language and may not convert the speech signal 810 into the text signal 820 when the speech signal 810 is the foreign language. In this case, the speech signal 810 may be used as an input of a second neural network 900 to be discussed in FIG. 9.

The first neural network 800 may include a structure in which data (input data) is input and input data is processed through hidden layers such that the processed data is output. The first neural network 800 may include a layer formed between an input layer and a hidden layer, layers formed between a plurality of hidden layers, and a layer formed between a hidden layer and an output layer. Two adjacent layers may be connected by a plurality of edges.

Each of the plurality of layers forming the first neural network 800 may include one or more nodes. A speech signal may be input to a plurality of nodes of the first neural network 800. Because each of the nodes has a corresponding weight value, the first neural network 800 may obtain output data based on a value obtained through an operation, for example, a multiplication operation, on an input signal and the weight value.

The first neural network 800 may include a speech identification model using an AI model such as a recurrent neural network (RNN). The first neural network 800 may train and process data that varies over time, such as time-series data. The first neural network 800 may be a neural network for performing natural language processing such as speech to text.

The first neural network 800 may add a ‘recurrent weight’ which is a weight that returns to itself from a neuron of the hidden layer, using a structure in which output returns to store a state of the hidden layer, to obtain the text signal 820 from the speech signal 810.

The first neural network 800 may include a circular neural network of a long-short term memory (LSTM). The first neural network 800 may include a LSTM that is sequence learning to use an LSTM network together with the RNN.

FIG. 9 is a diagram for explaining the computing apparatus 200 for obtaining keywords 910 from the text signal 820 according to an embodiment of the disclosure.

Referring to FIG. 9, the second neural network 900 may be a model trained to receive the text signal 820 and output certain words of the text signal 820 as the keywords 910. In an embodiment of the disclosure, the second neural network 900 may determine from the text signal 820 words that are helpful in determining a genre of a channel, and may obtain words that are helpful in determining the genre of the channel as the keywords 910.

Accordingly, because only the words that are helpful in determining the genre of the channel are obtained as the keywords 910, the genre of the channel may be determined more accurately.

In an embodiment of the disclosure, the second neural network 900 may obtain the keywords 910 from a subtitle reproduced together with a speech signal. In this case, the second neural network 900 may receive a subtitle corresponding to content output from the channel from a server, and use the subtitle as an input. The second neural network 900 may extract the keywords 910 directly from the subtitle using the subtitle without using a speech signal received through the channel.

In FIG. 9, the keywords 910 are words indicated in a square block in the text signal. The second neural network 900 may include a structure in which input data is received and input data is processed through hidden layers such that the processed data is output.

The second neural network 900 may be a DNN including two or more hidden layers. The second neural network 900 may be a DNN including am input layer, an output layer, and two or more hidden layers. The second neural network 900 may include a layer formed between an input layer and a hidden layer, layers formed between a plurality of hidden layers, and a layer formed between a hidden layer and an output layer. Two adjacent layers may be connected by a plurality of edges.

Each of the plurality of layers forming the second neural network 900 may include one or more nodes. The text signal may be input to a plurality of nodes of the second neural network 900. Because each of the nodes has a corresponding weight value, the second neural network 900 may obtain output data based on a value obtained through an operation, for example, a multiplication operation, on an input signal and the weight value.

The second neural network 900 may be constructed as a model trained based on a plurality of text signals to identify the keywords 910 that are helpful in determining the genre among the text signals.

The second neural network 900 may be mechanism to cause a deep learning model to concentrate on a specific vector and additionally performed on a result of the first neural network 800, thereby improving performance of the model with respect to a long sequence. The computing apparatus 200 may obtain the keywords 910 from the text signal 820 by using the second neural network 900.

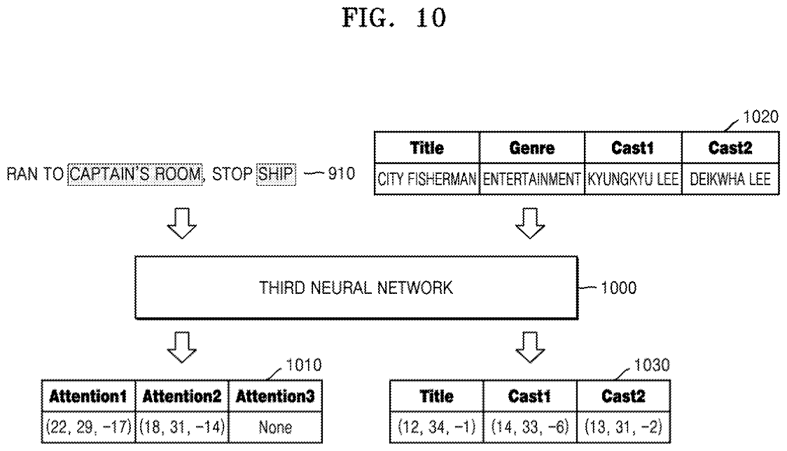

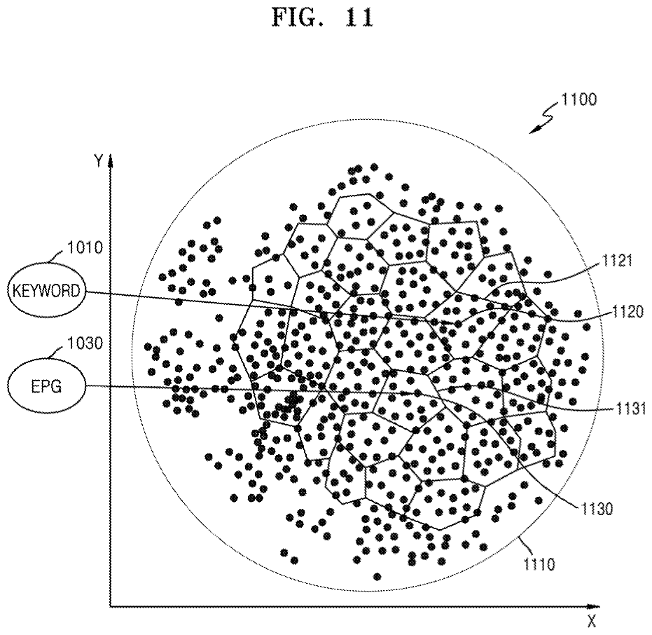

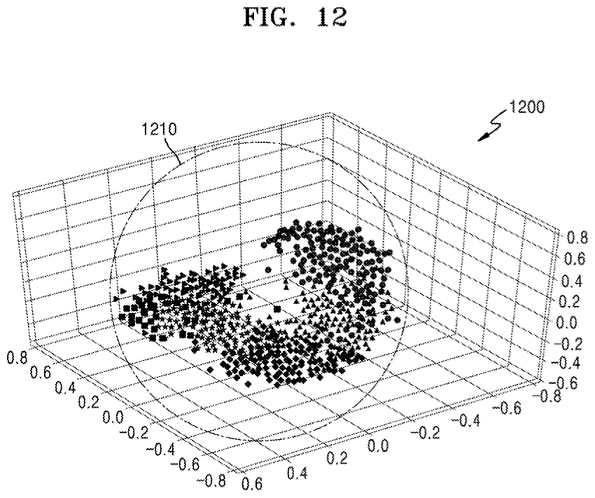

FIG. 10 is a diagram for explaining the computing apparatus 200 for obtaining numerical vectors 1010 and 1030 respectively from the keywords 910 and genre information 1020 according to an embodiment of the disclosure.

Referring to FIG. 10, the computing apparatus 200 may convert the keywords 910 into the numerical vector 1010 with respect to a keyword using a third neural network 1000. The computing apparatus 200 may also obtain the genre information 1020 from metadata and convert the genre information 1020 into the numerical vector 1030 with respect to genre information using the third neural network 1000.

Accordingly, the keywords 910 and the genre information 1020 may be converted into a form such that similarity of two pieces of information may be determined.

The third neural network 1000 according to an embodiment of the disclosure may be a model trained to receive specific information and output a numerical vector corresponding to the specific information. The third neural network 1000 may be a machine learning model that receives the keywords 910 and the genre information 1020 as input and then converts the keywords 910 and the genre information 1020 into numerical data in the form of a multidimensional vector.

The third neural network 1000 may obtain a value of a genre relation of each of the keyword 910 and the genre information 1020 as a vector. The third neural network 1000 may map and output each numerical vector to a point on a two-dimensional or three-dimensional graph. The third neural network 1000 is a network used for embedding a meaning connoting word as a vector, and may express words in a distributional manner by using word2vec or a distributed representation.

FIG. 11 is one graph showing numerical vectors of FIG. 10. FIG. 12 is another graph showing numerical vectors of FIG. 10.

Referring to FIG. 11, output information of the third neural network 1000 may be expressed as a two-dimensional graph 1100. In FIG. 11, the numerical vector output from the third neural network 1000 may be expressed as dots 1110 on the two-dimensional graph 1100. The output information of the third neural network 1000 may be expressed in a different position on the two-dimensional graph 1100 according to a genre relation.

Referring to FIG. 12, the numerical vector output from the third neural network 1000 may be expressed as dots 1210 on a three-dimensional graph 1200.

In FIGS. 11 and 12, the computing apparatus 200 may use a graph output from the third neural network 1000 as an input value of a fourth neural network (not shown) to determine similarity of two vectors.

In an embodiment of the disclosure, the fourth neural network may obtain similarity of numerical vectors by measuring a distance between the dots 1110 and 1210 indicated on the graph 1100 or 1200 of FIG. 11 or 12. The fourth neural network may understand that the closer the distance between the numerical vectors is, the higher the relation is by measuring the distance by using a Euclidean method or the like. In FIG. 11, X-axis and Y-axis values of the two-dimensional graph 1100 may indicate fields related to channel genres. For example, according to a position of a dot in the graph 1100, a genre of a channel may be closer to the news as the dot goes to the upper right, and the genre of the channel may be closer to the movie as the dot goes to the lower right. In FIG. 11, the fourth neural network may measure a distance between two dots 1120 and 1130 of the numerical vector 1010 with respect to the keyword and the numerical vector 1030 with respect to the genre information located on the two-dimensional graph 1100 to determine similarity of two numerical vectors.

In another embodiment of the disclosure, the four neural network may be a model trained to output the similarity of input data by using a clustering model or the like. The fourth neural network may be a model trained to understand that when the numerical vectors are grouped in the same cluster by clustering vectors that are reduced to a low dimension such as a two-dimension or a three-dimension by using a k-means clustering model, the relation between the vectors is high.

For example, in FIG. 11, the numerical vector 1010 with respect to the keyword may be expressed as the certain dot 1120 in one cell 1121 on the two-dimensional graph 1100, and the numerical vector 1030 with respect to the genre information may be expressed as the other dot 1130 in another cell 1131 on the two-dimensional graph 1100. The fourth neural network may group numerical vectors including similar characteristics into cells based on characteristics of the numerical vectors. The fourth neural network may determine that there is no genre relation of the channel because the numerical vector 1010 with respect to the keyword and the numerical vector 1030 with respect to the genre information are not included in the same cell.

In another embodiment of the disclosure, the output information of the third neural network 1000 may be displayed on the graph in different colors, different intensities, or different shapes of output according to the relation with the genre of the channel. For example, as shown in FIG. 12, the numerical vector output from the third neural network 1000 may be expressed as the dots 1210 having different shapes on the three-dimensional graph 1200. The dots 1210 of different shapes on the three-dimensional graph 1200 may represent a genre related field in the three-dimensional graph 1200. For example, round dots displayed on the three-dimensional graph 1200 indicate a case where the genre of the channel is a movie, and diamond shape dots may indicate a case where the genre of the channel is the news.

The fourth neural network may be a DNN including two or more hidden layers. The fourth neural network may include a structure in which input data is processed through the hidden layers such that the processed data is output.

The computing apparatus 200 may obtain the similarity of numerical vectors by using the fourth neural network. The computing apparatus 200 may determine the genre of the channel as a genre according to the genre information when it is determined that the similarity of the two numerical vectors is high according to a result of the fourth neural network.

Accordingly, the computing apparatus 200 may more accurately determine the genre of the channel by using a speech signal which is less data than an image signal. In addition, the computing apparatus 200 may more promptly determine the genre of the channel with less data.

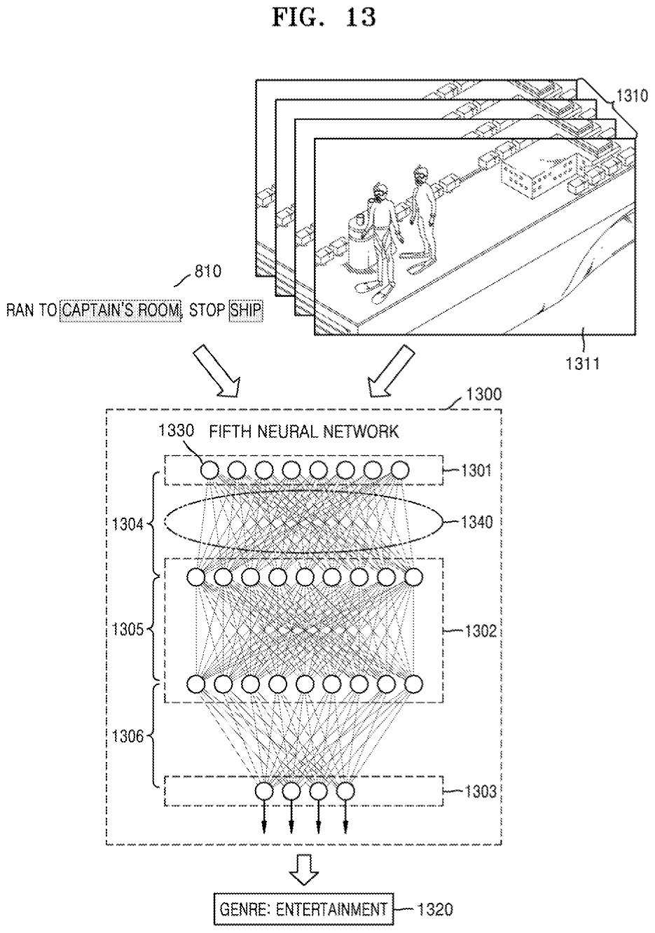

FIG. 13 is a diagram for explaining the computing apparatus 200 for determining a genre of a channel using an image signal 1311 and the keyword 910 according to an embodiment of the disclosure.

Referring to FIG. 13, the computing apparatus 200 may include a fifth neural network 1300. The fifth neural network 1300 may be a model trained to receive the keyword 910 and the image signal 1311 and determining what is a genre 1320 of a media signal output from the channel using the keyword 910 and the image signal 1311. The computing apparatus 200 may determine the genre of the channel by analyzing the image signal 1311. At this time, the computing apparatus 200 may use the previously obtained keyword 910 in addition to the image signal 1311.

The computing apparatus 200 may obtain an image signal in a channel on which a speech signal is output when relation of numerical vectors goes beyond a certain threshold as a result of a determination using a fourth neural network.

In an embodiment of the disclosure, the computing apparatus 200 may perform an operation on a keyword to obtain a probability value for each genre, and determine relation of the keyword and gene information by using whether a probability value that a genre of a broadcast channel is a genre according to the genre information exceeds a certain threshold value.

When the relation of the keyword and gene information does not exceed a certain threshold value, the computing apparatus 200 may obtain an image signal included in a broadcast signal, by using a fifth neural network, analyze the image signal and the keyword, and determine a genre corresponding to the broadcast channel.

Accordingly, the computing apparatus 200 may more accurately analyze the genre of the channel by using the genre information and the image signal together.

The computing apparatus 200 may obtain the image signal 1311 included in the broadcast channel signal and reproduced together with the speech signal at the same time as the speech channel among the plurality of image signals 1310. In the same channel, the image signal 1311 reproduced together with the speech signal may be a signal having a very high closeness with the speech signal.

Accordingly, because an image signal reproduced together with a speech signal at the time when the speech signal is reproduced is used together with a keyword with respect to the speech signal to determine the genre of the channel, the genre of the channel may be determined more accurately.

The fifth neural network 1300 may be a DNN including two or more hidden layers. The fifth neural network 1300 may include a structure in which input data is received, and the input data is processed through the hidden layers such that the processed data is output. The fifth neural network 1300 may include a convolution neural network (CNN).

The computing apparatus 200 may output the resultant genre1320 from the keyword 910 and the image signal 1311 by using the fifth neural network 1300. In FIG. 13, a case where the hidden layer of the fifth neural network 1300 is a DNN having two depths is illustrated as an example.

The computing apparatus 200 may perform an operation through the fifth neural network 1300 to analyze the image signal and the keyword. The fifth neural network 1300 may perform learning through learning data. The trained fifth neural network 1300 may perform a reasoning operation which is an operation for analyzing the image signal. Here, the fifth neural network 1300 may be designed very variously according to an implementation method (e.g., a CNN, etc.) of a model, accuracy of results, reliability of results, an operation processing speed and capacity of a processor, etc.

The fifth neural network 1300 may include an input layer 1301, a hidden layer 1302, and an output layer 1303 to perform an operation for determining the genre. The fifth neural network 1300 may include a first layer 1304 formed between the input layer 1301 and a first hidden layer, a second layer 1305 formed between the first hidden layer and a second hidden layer, and a third layer 1306 formed between the second hidden layer and the output layer 1303.

Each of the plurality of layers forming the fifth neural network 1300 may include one or more nodes. For example, the input layer 1301 may include one or more nodes 1330 that receive data. FIG. 13 illustrates an example in which the input layer 1301 includes a plurality of nodes. A plurality of images obtained by scaling the image signal 1311 may be input to the plurality of nodes 1330. Specifically, the plurality of images obtained by scaling the image signal 1311 for each frequency band may be input to the plurality of nodes 1330.

Here, two adjacent layers may be connected by a plurality of edges (e.g. 1340). Because each of the nodes has a corresponding weight value, the fifth neural network 1300 may obtain output data based on a value obtained through an operation, for example, a multiplication operation, on an input signal and the weight value.

The fifth neural network 1300 may be constructed as a model trained based on a plurality of learning images to identify an object included in the images and determine a genre. Specifically, to increase accuracy of a result output through the fifth neural network 1300, training may be repeatedly performed in a direction of the input layer 1301 in the output layer 1303 based on the plurality of learning images and weight values may be modified to increase the accuracy of the output result.

The fifth neural network 1300 having the finally modified weight values may be used as a genre determination model. Specifically, the fifth neural network 1300 may analyze information included in the image signal 1311 and the keyword 910 as input data and output the resultant genre1320 indicating the genre of the channel from which the image signal 1311 is output. In FIG. 13, the fifth neural network 1300 may analyze the image signal 1311 and the keyword 910 of the channel and output the resultant genre 1320 that the genre of the signal of the channel is an entertainment.

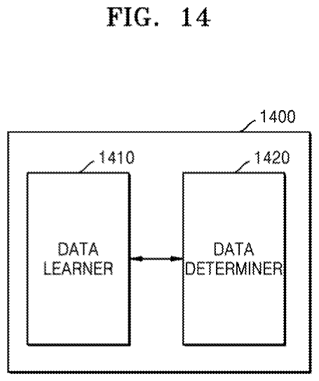

FIG. 14 is a block diagram illustrating a configuration of the processor 220 according to an embodiment of the disclosure.

Referring to FIG. 14, the processor 220 according to an embodiment of the disclosure may include a data learner 1410 and a data determiner 1420.

The data learner 1410 may learn a reference for determining a genre of a channel from a media signal output from the channel. The data learner 1410 may learn the reference about what information to use for determining the genre of the channel from the media signal. The data learner 1410 may learn the reference about how to determine the genre of the channel from the media signal. The data learner 1410 may obtain data to be used for learning, and apply the obtained data to the data determination model to be described later, thereby learning the reference for determining a state of a user.

The data determiner 1420 may determine the genre of the channel from the media signal and output a result of determination. The data determiner 1420 may determine the genre of the channel from the media signal by using a trained data determination model. The data determiner 1420 may obtain a keyword from a speech signal according to a pre-set reference by learning and use the data determination model having the obtained keyword and genre information as input values. Further, the data determiner 1420 may obtain a resultant value of the genre of the channel from the speech signal and the genre information by using the data determination model. Also, a resultant value output by the data determination model having the obtained resultant value as the input value may be used to refine the data determination model.

At least one of the data learner 1410 or the data determiner 1420 may be manufactured in the form of at least one hardware chip and mounted on an electronic apparatus. For example, at least one of the data learner 1410 or the data determiner 1420 may be manufactured in the form of a dedicated hardware chip for AI or may be manufactured as a part of an existing general purpose processor (e.g. a CPU or an application processor) or a graphics-only processor (e.g., a GPU) and mounted on the electronic apparatus.

In this case, the data learner 1410 and the data determiner 1420 may be mounted on one electronic apparatus or may be mounted on separate electronic apparatuses. For example, one of the data learner 1410 and the data determiner 1420 may be included in the electronic apparatus, and the other may be included in a server. The data learner 1410 and the data determiner 1420 may provide model information constructed by the data learner 1410 to the data determiner 1420 by wired or wirelessly, and provide data input to the data determiner 1420 to the data learner 1410 as additional training data.

Meanwhile, at least one of the data learner 1410 or the data determiner 1420 may be implemented as a software module. When the at least one of the data learner 1410 or the data determiner 1420 is implemented as the software module (or a program module including an instruction), the software module may be stored in non-transitory computer readable media. Further, in this case, at least one software module may be provided by an operating system (OS) or by a certain application. Alternatively, one of the at least one software module may be provided by the OS, and the other one may be provided by the certain application.

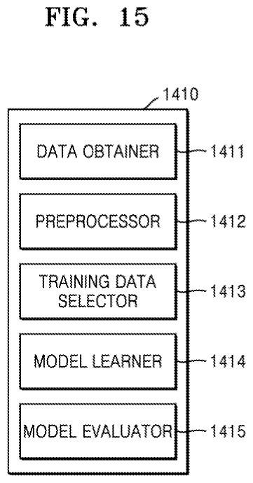

FIG. 15 is a block diagram of the data learner 1410 according to an embodiment of the disclosure.

Referring to FIG. 15, the data learner 1410 according to an embodiment of the disclosure may include a data obtainer 1411, a preprocessor 1412, a training data selector 1413, a model learner 1414 and a model evaluator 1415.

The data obtainer 1411 may obtain data for determining a genre of a channel. The data obtainer 1411 may obtain data from an external server such as a content providing server such as a social network server, a cloud server, or a broadcast station server.

The data obtainer 1411 may obtain data necessary for learning for determining the genre from a media signal of the channel. For example, the data obtainer 1411 may obtain a speech signal and genre information from at least one external apparatus connected to the computing apparatus 200 over a network. When the genre of the channel is not determined from the speech signal and the genre information, the data obtainer 1411 may obtain the speech signal from the media signal.

The preprocessor 1412 may pre-process the obtained data such that the obtained data may be used for learning for determining the genre of the channel from the media signal. The preprocessor 1412 may process the obtained data in a pre-set format such that the model learner 1414, which will be described later, may use the obtained data for learning for determining the genre of the channel from the media signal. For example, the preprocessor 1412 may analyze the obtained media signal to process the speech signal in the pre-set format but the disclosure is not limited thereto.

The training data selector 1413 may select data necessary for learning from the preprocessed data. The selected data may be provided to the model learner 1414. The training data selector 1413 may select the data necessary for learning from the preprocessed data according to a pre-set reference for determining the genre of the channel from the media signal. In an embodiment of the disclosure, the training data selector 1413 may select keywords that are helpful in determining the genre of the channel from the speech signal.

The training data selector 1413 may also select the data according to a pre-set reference by learning by the model learner 1414 which will be described later.

The model learner 1414 may learn a reference as to which training data is used to determine the genre of the channel from the speech signal. For example, the model learner 1414 may learn types, the number, or levels of keyword attributes used for determining the genre of the channel from a keyword obtained from the speech signal.

Also, the model learner 1414 may learn a data determination model used to determine the genre of the channel from the speech signal using the training data. In this case, the data determination model may be a previously constructed model. For example, the data determination model may be a previously constructed model by receiving basic training data (e.g., a sample image, etc.)

The data determination model may be constructed in consideration of an application field of a determination model, a purpose of learning, or the computer performance of an apparatus, etc. The data determination model may be, for example, a model based on a neural network. For example, a model such as Deep Neural Network (DNN), Recurrent Neural Network (RNN), and Bidirectional Recurrent Deep Neural Network (BRDNN) may be used as the data determination model, but the disclosure is not limited thereto.

According to an embodiment of the disclosure, when there are a plurality of data determination models that are previously constructed, the model learner 1414 may determine a data determination model having a high relation between input training data and basic training data as the data determination model. In this case, the basic training data may be previously classified according to data types, and the data determination model may be previously constructed for each data type. For example, the basic training data may be previously classified according to various references such as a region where the training data is generated, a time at which the training data is generated, a size of the training data, a genre of the training data, a creator of the training data, a type of an object in the training data, etc.

Also, the model learner 1414 may train the data determination model using a learning algorithm including, for example, an error back-propagation method or a gradient descent method.

Also, the model learner 1414 may train the data determination model through supervised learning using, for example, the training data as an input value. Also, the model learner 1414 may train the data determination model through unsupervised learning to find the reference for situation determination by learning a type of data necessary for situation determination for itself without any guidance. Also, the model learner 1414 may train the data determination model, for example, through reinforcement learning using feedback on whether a result of situation determination based on the learning is correct.

Further, when the data determination model is trained, the model learner 1414 may store the trained data determination model. In this case, the model learner 1414 may store the trained data determination model in the memory 1700 of the device including the data determiner 1420. Alternatively, the model learner 1414 may store the trained data determination model in a memory of an apparatus including the data determiner 1420 that will be described later. Alternatively, the model learner 1414 may store the trained data determination model in a memory of a server connected to the device over a wired or wireless network.

In this case, the memory 1700 in which the trained data determination model is stored may also store, for example, a command or data related to at least one other component of the electronic apparatus. The memory may also store software and/or program. The program may include, for example, a kernel, middleware, an application programming interface (API), and/or an application program (or “application”).

The model evaluator 1415 may input evaluation data to the data determination model, and when a recognition result output from the evaluation data does not satisfy a certain reference, the model evaluator 1415 may allow the model learner 1414 to be trained again. In this case, the evaluation data may be pre-set data for evaluating the data determination model.

For example, when the number or a ratio of evaluation data having an incorrect recognition result among recognition results of the trained data determination model with respect to the evaluation data exceeds a pre-set threshold value, the model evaluator 1415 may evaluate that the data determination model does not satisfy the certain reference. For example, when the certain reference is defined as a ratio of 2%, and when the trained data determination model outputs an incorrect recognition result with respect to evaluation data exceeding 20 among a total of 1000 evaluation data, the model evaluator 1415 may evaluate that the trained data determination model is not suitable.

On the other hand, when there are a plurality of trained data determination models, the model evaluator 1415 may evaluate whether each of the trained motion determination models satisfies the certain reference and determine a model satisfying the certain reference as a final data determination model. In this case, when a plurality of models satisfy the certain reference, the model evaluator 1415 may determine any one or a pre-set number of models previously set in descending order of evaluation scores as the final data determination model.

Meanwhile, at least one of the data obtainer 1411, the preprocessor 1412, the training data selector 1413, the model learner 1414, or the model evaluator 1415 in the data learner 1410 may be manufactured in the form of at least one hardware chip and mounted on the electronic apparatus. For example, the at least one of the data obtainer 1411, the preprocessor 1412, the training data selector 1413, the model learner 1414, or the model evaluator 1415 may be manufactured in the form of a dedicated hardware chip for AI or may be manufactured as a part of an existing general purpose processor (e.g.

a CPU or an application processor) or a graphics-only processor (e.g., a GPU) and mounted on the electronic apparatus.

Also, the data obtainer 1411, the preprocessor 1412, the training data selector 1413, the model learner 1414, and the model evaluator 1415 may be mounted on one electronic apparatus or may be mounted on separate electronic apparatuses. In an embodiment of the disclosure, the electronic apparatus may include a computing apparatus, an image display apparatus, or the like. For example, some of the data obtainer 1411, the preprocessor 1412, the training data selector 1413, the model learner 1414, and the model evaluator 1415 may be included in the device, and the others may be included in a server.

Also, at least one of the data obtainer 1411, the preprocessor 1412, the training data selector 1413, the model learner 1414, or the model evaluator 1415 may be implemented as a software module. When the at least one of the data obtainer 1411, the preprocessor 1412, the training data selector 1413, the model learner 1414, or the model evaluator 1415 is implemented as the software module (or a program module including an instruction), the software module may be stored in non-transitory computer readable media. Further, in this case, at least one software module may be provided by an OS or by a certain application. Alternatively, one of the at least one software module may be provided by the OS, and the other one may be provided by the certain application.

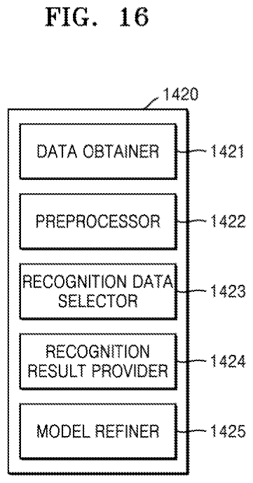

FIG. 16 is a block diagram of the data determiner 1420 according to an embodiment of the disclosure.

Referring to FIG. 16, the data determiner 1420 according to an embodiment of the disclosure may include a data obtainer 1421, a preprocessor 1422, a recognition data selector 1423, a recognition result provider 1424 and a model refiner 1425.

The data obtainer 1421 may obtain data for determining a genre of a channel from a speech signal. The data for determining the genre of the channel from the speech signal may be keywords and genre information obtained from the speech signal. When the genre of the channel is not determined using the speech signal and the genre, the data obtainer 1421 may obtain an image signal from a media signal. The preprocessor 1422 may preprocess the obtained data such that the obtained data may be used. The preprocessor 1422 may process the obtained data to a pre-set format such that the recognition result provider 1424, which will be described later, may use the obtained data for determining the genre of the channel from the speech signal.

The recognition data selector 1423 may select data necessary for determining the genre of the channel from the speech signal in the preprocessed data. The selected data may be provided to the recognition result provider 1424. The recognition data selector 1423 may select some or all of the preprocessed data according to a pre-set reference for determining the genre of the channel from the speech signal.

The recognition result provider 1424 may determine the genre of the channel from the speech signal by applying the selected data to a data determination model. The recognition result provider 1424 may provide a recognition result according to a data recognition purpose. The recognition result provider 1424 may apply the selected data to the data determination model by using the data selected by the recognition data selector 1423 as an input value. Also, the recognition result may be determined by the data determination model.

The recognition result provider 1424 may provide identification information indicating the determined genre of the channel from the speech signal. For example, the recognition result provider 1424 may provide information about a category including an identified object or the like.

The model refiner 1425 may modify the data determination model based on evaluation of the recognition result provided by the recognition result provider 1424. For example, the model refiner 1425 may provide the model learner 1414 with the recognition result provided by the recognition result provider 1424 such that the model learner 1414 may modify the data determination model.

Meanwhile, at least one of the data obtainer 1421, the preprocessor 1422, the recognition data selector 1423, the recognition result provider 1424, or the model refiner 1425 in the data determiner 1420 may be manufactured in the form of at least one hardware chip and mounted on the device. For example, the at least one of the data obtainer 1421, the preprocessor 1422, the recognition data selector 1423, the recognition result provider 1424, or the model refiner 1425 may be manufactured in the form of a dedicated hardware chip for AI or may be manufactured as a part of an existing general purpose processor (e.g. a CPU or an application processor) or a graphics-only processor (e.g., a GPU) and mounted on the electronic apparatus.

Also, the data obtainer 1421, the preprocessor 1422, the recognition data selector 1423, the recognition result provider 1424, and the model refiner 1425 may be mounted on one device or may be mounted on separate electronic apparatuses. For example, some of the data obtainer 1421, the preprocessor 1422, the recognition data selector 1423, the recognition result provider 1424, and the model refiner 1425 may be included in an electronic apparatus, and the others may be included in a server.

Also, at least one of the data obtainer 1421, the preprocessor 1422, the recognition data selector 1423, the recognition result provider 1424, or the model refiner 1425 may be implemented as a software module. When the at least one of the data obtainer 1421, the preprocessor 1422, the recognition data selector 1423, the recognition result provider 1424, or the model refiner 1425 is implemented as the software module (or a program module including an instruction), the software module may be stored in non-transitory computer readable media. Further, in this case, at least one software module may be provided by an OS or by a certain application. Alternatively, one of the at least one software module may be provided by the OS, and the other one may be provided by the certain application.

A computing apparatus according to an embodiment of the disclosure may classify contents of a channel for each genre by using a small amount of resources using a speech signal.

The computing apparatus according to an embodiment of the disclosure may classify and output the contents of the channel for each genre in real time.

An image display apparatus and an operation method thereof according to some embodiments of the disclosure may be implemented as a recording medium including computer-readable instructions such as a computer-executable program module. The computer-readable medium may be an arbitrary available medium accessible by a computer, and examples thereof include all volatile and non-volatile media and separable and non-separable media. Further, the computer-readable medium may include both a computer storage medium and a communication medium. Examples of the computer storage medium include all volatile and non-volatile media and separable and non-separable media, which are implemented by an arbitrary method or technology, for storing information such as computer-readable instructions, data structures, program modules, or other data. The communication medium generally includes computer-readable instructions, data structures, program modules, other data of a modulated data signal, or other transmission mechanisms, and examples thereof include an arbitrary information transmission medium.

Also, in this specification, the term “unit” may be a hardware component such as a processor or a circuit, and/or a software component executed by a hardware component such as a processor.

Also, the image display apparatus and an operation method thereof according to some embodiments of the disclosure may be implemented as a computer program product including a recording medium storing thereon a program to perform operations of obtaining a sentence including multiple languages; and an operation of obtaining a vector value corresponding to each of words included in the sentence including the multiple languages using a multilingual translation model, converting the obtained vector values into vector values corresponding to a target language, and obtaining a sentence configured in the target language based on the converted vector values.

It will be understood by those of ordinary skill in the art that the foregoing description of the disclosure is for illustrative purposes only and that those of ordinary skill in the art may readily understand that various changes and modifications may be made without departing from the spirit or essential characteristics of the disclosure. It is therefore to be understood that the above-described embodiments of the disclosure are illustrative in all aspects and not restrictive. For example, each component described as a single entity may be distributed and implemented, and components described as being distributed may also be implemented in a combined form.

1. A computing apparatus comprising:
a memory storing one or more instructions; and
a processor configured to execute the one or more instructions stored in the memory to:
obtain a keyword corresponding to a broadcast channel from a speech signal included in a broadcast signal received through the broadcast channel;
determine a relation between genre information of the broadcast channel obtained from metadata about the broadcast channel and the obtained keyword; and
determine a genre of the broadcast channel based on the genre information obtained from the metadata or by analyzing an image signal included in the broadcast signal, according to the determined relation.

2. The computing apparatus of claim 1, wherein the processor is further configured to obtain the speech signal from the broadcast signal and obtain the keyword corresponding to the broadcast channel from the obtained speech signal, every set period.

3. The computing apparatus of claim 1, wherein the processor is further configured to, by using a learning model using one or more neural networks, convert the speech signal into a text signal and obtain the keyword from the text signal.

4. The computing apparatus of claim 3, wherein the processor is further configured to
determine whether the speech signal is a human utterance, and
convert the speech signal into the text signal based on that the speech signal is the human utterance.

5. The computing apparatus of claim 3, wherein the processor is further configured to obtain, as the keyword, a word that is helpful in determining a genre of a channel from the text signal.

6. The computing apparatus of claim 3, wherein the processor is further configured to obtain the keyword from a subtitle reproduced together with the speech signal based on that the speech signal is a foreign language.

7. The computing apparatus of claim 1, wherein the processor is further configured to, by using a learning model using one or more neural networks,
perform an operation on the keyword to obtain a probability value of the broadcast channel for each genre, and,
based on that the probability value that a genre of the broadcast channel is a genre according to the genre information exceeds a certain threshold value, determine the genre of the broadcast channel according to the genre information.

8. The computing apparatus of claim 1, wherein the processor is further configured to, by using a learning model using one or more neural networks,
convert each of the genre information and the keyword into vectors, and
based on that a relation between the vectors is greater than a certain threshold value, determine a genre of the broadcast channel according to the genre information.

9. The computing apparatus of claim 8, wherein the processor is further configured to
obtain an image signal included in the broadcast signal based on that the relation is not greater than the certain threshold value, and
analyze the image signal and the keyword to determine the genre of the broadcast channel.

10. The computing apparatus of claim 1, wherein the image signal is included in the broadcast signal received through the broadcast channel and is reproduced at the same time as the speech channel.

11. The computing apparatus of claim 1, further comprising a display,
wherein the display outputs information about the determined genre of the broadcast channel, in response to a channel information request from a user.

12. The computing apparatus of claim 11, wherein, based on that a plurality of broadcast channels are determined to be of the same genre, the display outputs a plurality of image signals received through the plurality of broadcast signals of the same genre in a multi-view format.

13. The computing apparatus of claim 11, wherein, based on that a plurality of broadcast channels are determined to be of the same genre, the display outputs a plurality of image signals received through the plurality of broadcast signals of the same genre, in accordance with priorities according to one or more of a viewing history and a viewing rating of the user.

14. An operation method of a computing apparatus, the operation method comprising:
obtaining a keyword corresponding to a broadcast channel from a speech signal included in a broadcast signal received through the broadcast channel;
determining a relation between genre information of the broadcast channel obtained from metadata about the broadcast channel and the obtained keyword; and
determining a genre of the broadcast channel based on the genre information obtained from the metadata or by analyzing an image signal included in the broadcast signal, according to the determined relation.

15. A non-transitory computer-readable recording medium having recorded thereon a program for performing an operation method of a computing apparatus, the operation method comprising:
obtaining a keyword corresponding to a broadcast channel from a speech signal included in a broadcast signal received through the broadcast channel;
determining a relation between genre information of the broadcast channel obtained from metadata about the broadcast channel and the obtained keyword; and
determining a genre of the broadcast channel based on the genre information obtained from the metadata or by analyzing an image signal included in the broadcast signal according to the determined relation.
